(19) United States
(12) Patent Application Publication
(10) Pub. No.: US 2010/0283828 A1
(43) Pub. Date: Nov. 11, 2010

(54) MULTI-VIEW 3D VIDEO CONFERENCE DEVICE

(75) Inventors: Kan-Ju Lee, Taipei County (TW); Ming-Yen Lin, Taipei City (TW); Chi-Chang Lin, Taipei City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: UNIQUE INSTRUMENTS CO.LTD, Taipei City (TW)

(21) Appl. No.: 12/774,361

(22) Filed: May 5, 2010

(30) Foreign Application Priority Data
May 5, 2009 (TW) 098114790

(51) Int. Cl. H04N 7/14

(52) U.S. Cl. 348/14.08; 348/E07.077

(57) ABSTRACT

A multi-view 3D video conference device is provided. The multi-view 3D video conference device is mainly used on a personal computer (PC), and utilizes a multi-view image pickup device, a 2D and 3D touch screen, and a technology of a multi-view image compression and synthesis procedure to achieve multi-view 3D video conferences through transmission functions of conventional local area network (LAN) and the Internet.

### CROSS-REFERENCE TO RELATED APPLICATIONS

This non-provisional application claims priority under 35 U.S.C. §119(a) on Patent Application No(s). 098114790 filed in Taiwan, R.O.C. on May 5, 2009, the entire contents of which are hereby incorporated by reference.

### BACKGROUND OF THE INVENTION

1. Field of Invention

The present invention relates to a multi-view 3D video conference device, which is mainly used on a personal computer (PC), and utilizes a multi-view image pickup device, a 2D and 3D touch screen, and a technology of a multi-view image compression and synthesis procedure to achieve multi-view 3D video conferences through transmission capabilities of conventional local area network (LAN) and the Internet.

2. Related Art

FIG. 1 is a schematic drawing of a conventional network video system. Generally speaking, a video conference between two remote ends A and B is performed as follows. After a 2D image pickup device 10 is used to capture a 2D image I_{A} at the end A and an image compression process is performed on the 2D image I_{A} through a PC 30, a LAN 40 at the end A, the Internet 50, and a LAN 40′ at the end B are used to transfer the compressed 2D image I_{AC} to a PC 30′ at the end B. Then, the PC 30′ performs a decompression process on the compressed 2D image I_{AC}, and finally the 2D image I_{A} is displayed on a screen 20′ at the end B. Similarly, a 2D image I_{B} at the end B may also be transferred to and displayed on a screen 20 at the end A through the same mechanism but a reverse procedure. Therefore, the purpose of bi-directional and real-time video conferences is achieved. However, the conventional network video system cannot provide network video conferences having a better 3D effect due to the lack of 3D image capture and display capabilities.

### SUMMARY OF THE INVENTION

In view of the above deficiencies of the conventional network video technology, as shown in FIG. 2, the present invention is directed to a multi-view 3D video conference device, which is mainly used on a PC 400, and utilizes a multi-view image pickup device 100, a 2D and 3D touch screen 200, and a technology of a multi-view image compression and synthesis procedure 300 to achieve multi-view 3D video conferences through transmission capabilities of conventional LAN 450 and the Internet 500.

### BRIEF DESCRIPTION OF THE DRAWINGS

The present invention will become more fully understood from the detailed description given herein below for illustration only, and thus are not limitative of the present invention, and wherein:

FIG. 1 is a schematic drawing of a conventional network video system;

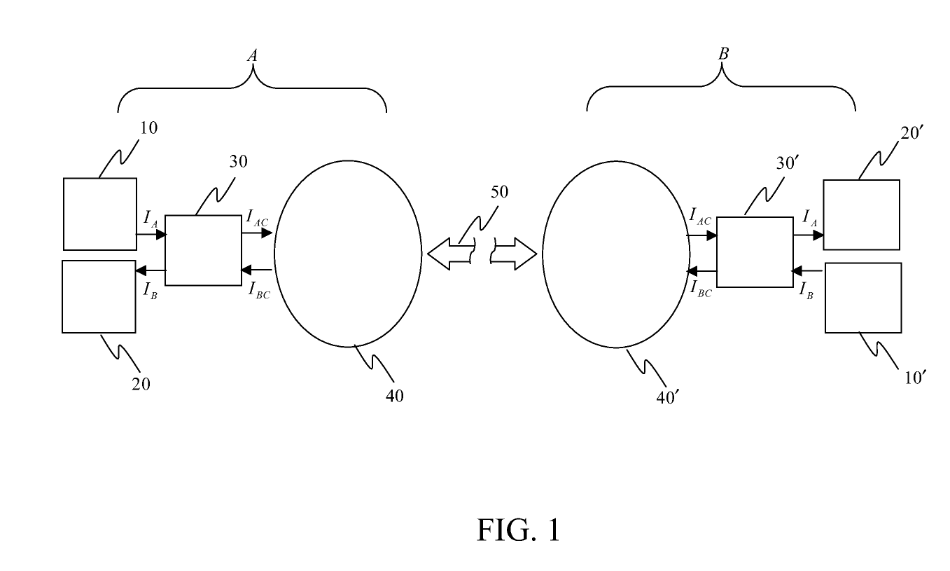

FIG. 2 is a schematic drawing of a multi-view 3D video conference device in the present invention;

FIG. 3 is a schematic drawing of a built-in multi-view image pickup device; and

FIG. 4 is a schematic drawing of a 2D and 3D touch screen.

### DETAILED DESCRIPTION OF THE INVENTION

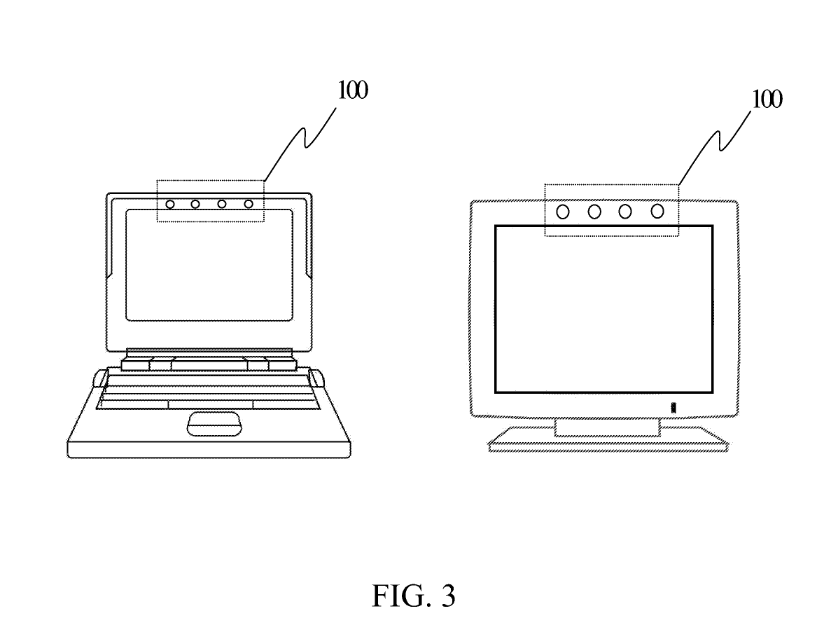

The multi-view image pickup device 100 mainly includes a plurality of (for example, four) image pickup elements 101, 102, 103, and 104. The synchronous capture control as well as mechanical adjustment control of a stereo base and a convergence angle required between the plurality of image pickup elements 101, 102, 103, and 104 are described in detail in ROC Patents No. 1243595 and No. 555022 and ROC Patent Applications No. 098113124 and No. 098113623, and thus will not be described herein. In addition, as shown in FIG. 3, for the convenience of use, the plurality of image pickup elements 101, 102, 103, and 104 may also be directly built in and mounted on a general monitor or notebook (NB) at an appropriate position. Therefore, the purpose of multi-view image capture can be achieved through the plurality of image pickup elements 101, 102, 103, and 104.

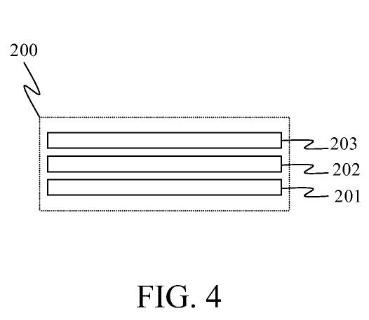

As shown in FIG. 4, the 2D and 3D touch screen 200 is mainly formed by a flat screen 201, a 2D and 3D image switchable parallax barrier 202, and a touch panel 203. The flat screen 201 may be a general flat panel display, such as a liquid crystal display (LCD) screen or an organic light emitting diode (OLED) screen. The touch panel 203 is a conventional touch panel for providing input through hand touch operations. The 2D and 3D image switchable parallax barrier 202 may present a state of transparency or barrier according to whether a voltage is applied or not, so as to display 2D or 3D images. Besides, the efficacy of 3D interface operations may also be achieved through the use of the touch panel 203. The configuration and efficacy of the 2D and 3D touch screen 200 are described in detail in ROC Patent Application No. 098114174, and thus will not be described herein.

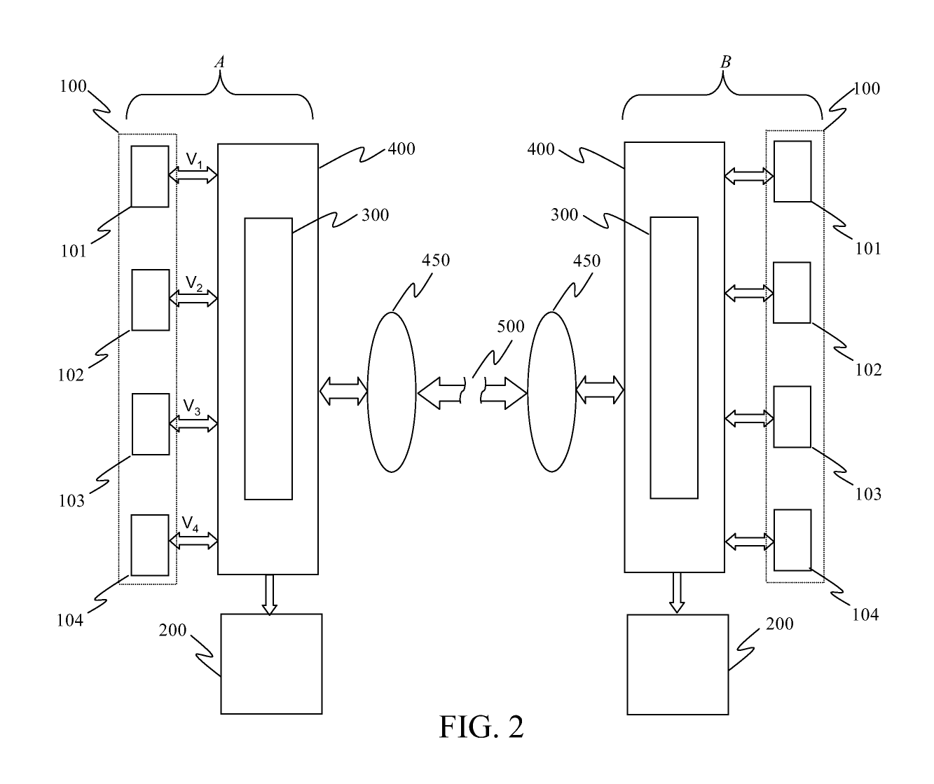

As shown in FIG. 2, the multi-view image compression and synthesis procedure 300 is installed in the PC 400, and mainly performs procedures of multi-view image reading, synthesis, compression, transfer, decompression, and display (not shown) on images V₁, V₂, V₃, and V₄ captured by the plurality of image pickup elements 101, 102, 103, and 104. The synthesis method of the multi-view images V₁, V₂, V₃, V₄ is described in detail in ROC Patent Application No. 097135421, and thus will not be described herein. The procedures of reading, compression, transfer, decompression, and display are general conventional image reading, compression, transfer, and decompression technologies, and also require no additional explanation. The display refers to displaying the decompressed image on the 3D touch screen 200. Therefore, the multi-view image compression and synthesis procedure 300 performs procedures of single-view image reading, multi-view image synthesis, multi-view image compression, and compressed multi-view image transfer at a sending end A, and performs procedures of compressed multi-view image decompression and multi-view image display at a receiving end B. Besides, the multi-view image compression and synthesis procedure 300 may also perform procedures of multi-view image reading, compression, transfer, decompression, synthesis, and display (not shown), i.e., first read the multi-view images V₁, V₂, V₃, and V₄ and perform image compression on individual views, and then individually transfer the compressed single-view images at the sending end A, and perform procedures of compressed single-view image decompression, multi-view image synthesis, and multi-view image display at the receiving end B.

To sum up, the present invention provides a multi-view 3D video conference device, which is mainly used on a PC, and utilizes a multi-view image pickup device, a 2D and 3D touch screen, and a technology of a multi-view image compression and synthesis procedure to achieve multi-view 3D video conferences through transmission capabilities of conventional LAN and the Internet. Although the present invention only describes the application in a PC or notebook(NB), the efficacy of multi-view 3D video conferences can also be achieved by installing the device on a personal digital assistant (PDA) or game console having a network transmission and a high computing capabilities. In addition, although the present invention only describes 3D video conferences in the one-to-one form, it should be understood that if the network transmission bandwidth is sufficient, the conventional 2D video conference network technology in the one-to-many form is also applicable in the application field of the present invention. Besides, the compression and decompression in the multi-view image compression and synthesis procedure may also be performed on chips, thereby greatly improving the processing efficiency.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A multi-view 3D video conference device, disposed on a personal computer (PC) or a notebook (NB), comprising:
a multi-view image pickup device, having a plurality of image pickup elements and capable of capturing multi-view images;
a 2D and 3D touch screen, capable of displaying the 2D and 3D images and providing a function of 3D interface operations; and
a multi-view image compression and synthesis procedure, installed in the PC or the NB for performing multi-view image reading, compression, transfer, decompression, synthesis, and display processes.

2. The multi-view 3D video conference device according to claim 1, wherein the plurality of image pickup elements is two or more image pickup elements.

3. The multi-view 3D video conference device according to claim 1, wherein the plurality of image pickup elements is built in and mounted on a monitor or the NB.

4. The multi-view 3D video conference device according to claim 1, wherein the 2D and 3D touch screen comprises a flat panel display, a 2D and 3D image switchable parallax barrier, and a touch panel.

5. The multi-view 3D video conference device according to claim 1, wherein the multi-view image compression and synthesis procedure performs procedures of single-view image reading, multi-view image synthesis, multi-view image compression, and compressed multi-view image transfer at a sending end, and performs procedures of compressed multi-view image decompression and multi-view image display at a receiving end.

6. The multi-view 3D video conference device according to claim 1, wherein the multi-view image compression and synthesis procedure performs single-view image reading, single-view image compression, and compressed single-view image transfer at a sending end, and performs procedures of compressed single-view image decompression, multi-view image synthesis, and multi-view image display at a receiving end.

7. The multi-view 3D video conference device according to claim 1, wherein the multi-view image compression and decompression processes are performed on chips, so as to improve a processing efficiency.

8. A multi-view 3D video conference device, disposed on a personal digital assistant (PDA), comprising:
a multi-view image pickup device, having a plurality of image pickup elements and capable of capturing multi-view images;
a 2D and 3D touch screen, capable of displaying the 2D and 3D images and providing a function of 3D interface operations; and
a multi-view image compression and synthesis procedure, installed in the PDA for performing multi-view image reading, compression, transfer, decompression, synthesis, and display processes.

9. A multi-view 3D video conference device, disposed on a gaming console, comprising:
a multi-view image pickup device, having a plurality of image pickup elements and capable of capturing multi-view images;
a 2D and 3D touch screen, capable of displaying the 2D and 3D images and providing a function of 3D interface operations; and
a multi-view image compression and synthesis procedure, installed in the game machine for performing multi-view image reading, compression, transfer, decompression, synthesis, and display processes.
